(19) United States
(12) Patent Application Publication
(10) Pub. No.: US 2014/0192691 A1
(43) Pub. Date: Jul. 10, 2014

(54) RELIABLE DELIVERY OF DATA SPECIFIED FOR TRANSMISSION BY MULTICASTING IN WIRELESS NETWORKS

(71) Applicant: GAINSPAN CORPORATION, San Jose, CA (US)

(72) Inventors: Pankaj Vyas, Bangalore (IN); Vishal Batra, Bangalore (IN)

(73) Assignee: GAINSPAN CORPORATION, San Jose, CA (US)

(21) Appl. No.: 13/735,051

(22) Filed: Jan. 7, 2013

(51) Int. Cl. H04W 4/06; H04W 52/02

(52) U.S. Cl. CPC H04W 4/06; H04W 52/0212
USPC 370/311; 370/312

(57) ABSTRACT

An access point (AP) of a WLAN maintains a list of wireless clients in the WLAN that belong to a special class. The AP receives data to be transmitted to the wireless clients as a multicast packet, and examines the list to determine whether any wireless clients belong to the special class. If none of the wireless clients belongs to the special class, the AP transmits the data as a multicast packet. However, if one or more wireless clients belong to the special class, the AP transmits the data in the form of unicast packets to each wireless client of the special class in addition to transmitting the data as a multicast packet.

### BACKGROUND OF THE INVENTION

1. Technical Field

Embodiments of the present disclosure relate generally to wireless networks, and more specifically to techniques for reliable delivery of data specified for transmission by multicasting in wireless networks.

2. Related Art

A wireless local area network (WLAN) generally refers to a network in which devices communicate with each other over a wireless medium in conformity with IEEE 802.11 family of standards. As is well known, such technologies rely on an access point (AP), which normally operates as a switching device to facilitate wireless stations to communicate with each other, and also potentially with devices external to a WLAN. On the other hand, wireless stations typically are either source (where data is created/formed for transmission by wireless network) or destination (the eventual machine to which the packet is delivered) of data.

WLAN standards often specify certain types of data, which can be transmitted using multicast packets. As used in the present application, a multicast refers to WLAN multicast in that the destination address field specifies that the packet is destined for multiple machines. In particular, a destination MAC address field in a packet with the octets 01-00-5E-xx-xx-xx (i.e., the higher order 25 bits of the 48-bit destination MAC address) specifies that the packet is a multicast packet, with the specific multicast group being identified by the value of xx-xx-xx. A broadcast is a specific instance of a multicast in that all the machines in the WLAN are destination stations for the corresponding packets. Unicast in the description herein similarly refers to WLAN unicast, unless the context clearly indicates otherwise.

Unfortunately, the protocol mechanism may not be geared for reliable delivery of multicast packets. Aspects of the present invention provide for such reliable delivery of such data specified for transmission as multicast packets.

### BRIEF DESCRIPTION OF THE VIEWS OF DRAWINGS

Example embodiments of the present invention will be described with reference to the accompanying drawings briefly described below.

FIG. 1 is a block diagram of an example environment in which several features of the present invention can be implemented.

FIG. 2 is a flowchart illustrating the manner in which multicast data destined for wireless clients of a wireless network is handled in an AP, in an embodiment.

FIG. 3A is a diagram of waveforms representing beacons of an AP and wake-durations of a client.

FIG. 3B is sequence diagram illustrating the sequence of operations that occur in transmission of unicast data according from an AP to a client.

FIG. 3C illustrates the manner in which multicast data is handled in an AP, in a prior embodiment.

FIGS. 4A, 4B and 4C together are diagrams illustrating the manner in which multicast data destined for clients are handled in an AP, in an embodiment.

FIGS. 5A and 5B depict packet formats used for sending ARP requests in the form of unicast packets and multicast packets respectively, in an embodiment.

FIG. 6 is a block diagram of the internal details of a wireless in an embodiment.

The drawing in which an element first appears is indicated by the leftmost digit(s) in the corresponding reference number.

### DETAILED DESCRIPTION

### 1. Overview

According to an aspect of the present invention, an access point (AP) of a WLAN maintains a list of wireless clients in the WLAN that belong to a special class. The AP receives a data packet to be transmitted to the wireless clients as a multicast packet, and examines the list to determine whether one or more of the wireless clients belongs to the special class. If none of the wireless clients belongs to the special class, the AP transmits the data as a multicast packet. However, if one or more wireless clients belong to the special class, the AP transmits the data in the form of unicast packets to each wireless client of the special class in addition to transmitting the data as a multicast packet. Such an approach may ensure reliable delivery of data specified for transmission by multicasting in wireless networks such as WLAN.

Several aspects of the invention are described below with reference to examples for illustration. It should be understood that numerous specific details, relationships, and methods are set forth to provide a full understanding of the invention. One skilled in the relevant arts, however, will readily recognize that the invention can be practiced without one or more of the specific details, or with other methods, etc. In other instances, well-known structures or operations are not shown in detail to avoid obscuring the features of the invention.

### 2. Example Environment

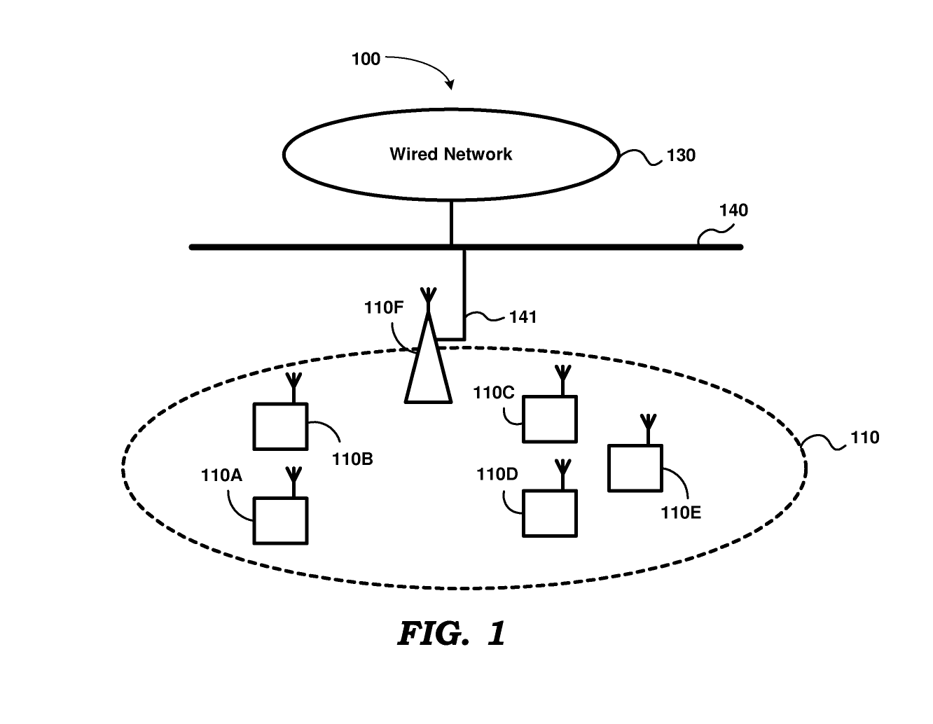

FIG. 1 is a block diagram illustrating an example environment in which several features of the present invention can be implemented. The example environment is shown containing only representative systems for illustration. However, real-world environments may contain many more systems/components as will be apparent to one skilled in the relevant arts. Further, in the description below, the components and the environment are described as operating consistent with IEEE 802.11 standard(s), merely for illustration. Implementations in other equivalent environments are also contemplated to be within the scope and spirit of several aspects of the present invention.

System 100 is shown containing client devices (clients) 110A-110E, access point (AP) 110F, wired network 130, and wired network backbone 140. Block 110 represents a basic service set (BSS) consistent with the 802.11 standard. Other environments may include more than one BSS, with the BSSs being interconnected to form an extended service set (ESS) consistent with IEEE 802.11 standards.

AP 110F is connected by a wired medium (141) to wired network backbone 140 and thus to wired network 130. Each of clients 110A-110E may communicate with AP 110F (as well as with each other) wirelessly according to any of the family of IEEE 802.11 protocols (including as specified in IEEE 802.11a, 802.11b, 802.11g and 802.11n) and thereby with wired network 130. Wired network 130 may represent the internet, also known as the World Wide Web. One or more of clients 110A-110E may correspond, for example, to a laptop computer, smart phone, or a wireless sensor.

AP 110F may receive data destined for final delivery (and consumption) to one or more of clients 110A-110E. Such data may originate, for example, from a device in wired network 130, a wireless client in another WLAN BSS, or from any of clients 110A-110E (not including the client which is the destination). Based on the specific nature of the data, AP 110F may be required by corresponding standards (e.g., IEEE 802.11) to transmit (forward) the data encapsulated either as a unicast packet or as a multicast (or broadcast) packet.

In case of unicast packets, and in accordance with the IEEE 802.11 standard, AP 110F indicates, in a beacon frame, the specific ones of clients 110A-110E for which unicast packets are currently available in the AP for delivery. Each of the indicated clients thereafter sends a PS-poll frame indicating availability to receive the corresponding unicast packets directed to it (the indicated client(s)). Thus, unicast data are generally received reliably by the corresponding client.

On the other hand, in the case of at least some type of multicast packets, an AP merely notifies (without waiting to receive a PS-Poll or similar message frame) the expected time frame of future transmission of the multicast packets. In such scenarios, reliable receipt of the data (multicast data) transmitted in multicast packets cannot be ensured at least in some scenarios. The manner in which such a problem is overcome in embodiments of the present invention is illustrated next with respect to a flowchart.

### 3. Reliable Delivery of Multicast Data

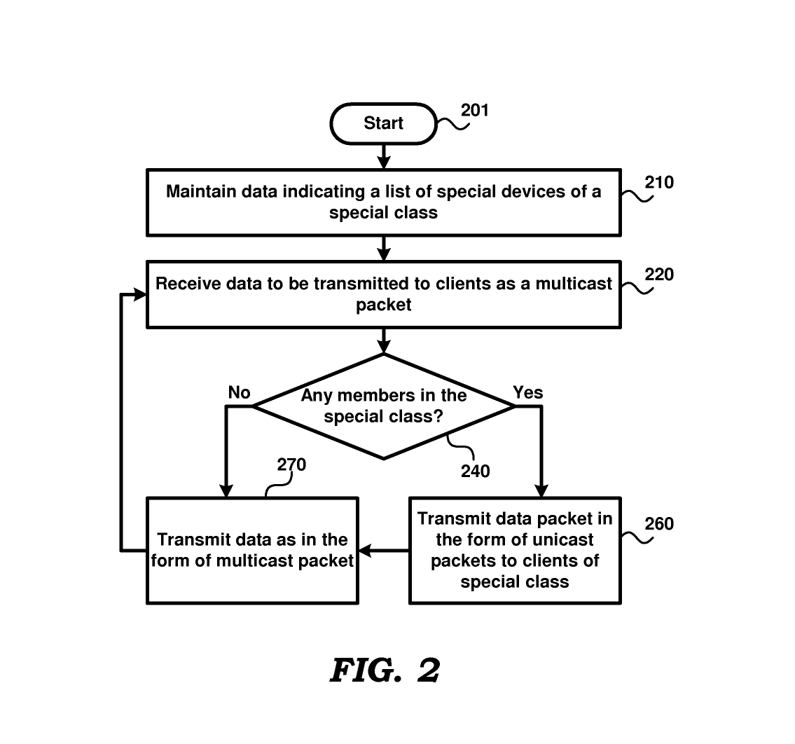

FIG. 2 is a flowchart illustrating the manner in which multicast data is delivered reliably, in an embodiment of the present invention. The steps in the flowchart are described with respect to FIG. 1, and with specific reference to AP 110F merely for illustration. Alternative embodiments in other environments, and using a different sequence of steps than shown can also be implemented without departing from the scope and spirit of several aspects of the present invention, as will be apparent to one skilled in the relevant arts by reading the disclosure provided herein. The flowchart starts in step 201, in which control passes immediately to step 210.

In step 210, AP 110F maintains data indicating a list of clients (within network BSS 110) of a special class. A separate list may be maintained for each multicast address of interest. A special class implies that AP 110F needs to handle/process multicast data destined for the clients of the special class differently than for clients not of the special class. The determination of whether a client belongs to the special class may be made based on one or more considerations, examples of which are provided below. Furthermore, the list may be constantly updated, parallel to performance of the other steps of the loop described below. Control then passes to step 220.

In step 220, AP 110F receives data, which is specified (e.g., by protocol, application or addressing convention) to be transmitted to clients (two or more of clients 110A-110E) in the form of multicast packet(s). The data may be received from a wireless station within BSS 110 or external to BSS (e.g., from wire network 130 or clients of another BSS). Control then passes to step 240.

In step 240, AP 110F determines whether the special class (for that multicast address) has any members (i.e., non-empty list). AP 110F may make such determination based on examination of the list of step 210. If there are any such clients in the special class for that multicast address, control passes to step 260, and to step 270 otherwise.

In step 260, AP 110F transmits the data received in step 220 in the form of unicast packets to clients of the special class. In other words, the same data, though received in step 220 for transmission as broadcast data, is transmitted in the form of multiple unicast packets, with each packet destined to corresponding one of the clients of the special class. As noted above, in 802.11 family of protocols, reliable delivery is ensured by first notifying the clients of the availability of the packet, and the client thereafter sending a PS-poll frame to request delivery of the buffered packet. Control then passes to step 270.

In step 270, AP 110F transmits the data received in step 220 as multicast packets. Thus, the same data received in step 220, is transmitted in the form of unicast packets in step 260, and multicast packet in step 270. The clients in the special status list may need to be accordingly designed to ignore the duplicate reception. Control then passes to step 220, and the corresponding steps of the flowchart may be repeated in a corresponding loop.

It may be appreciated that the above approach ensures reliable delivery of multicast data to clients of the special class by transmitting the data as unicast packets. Transmission of multicast data to ‘conventional’ clients (i.e., clients not belonging to the special class) remains unchanged and occurs as per the IEEE 802.11 (WLAN) specifications.

### 4. Example Problem

An example situation in which such an approach may be useful is when clients of a WLAN network are allowed to operate in “sleep” modes to reduce power consumption. For example, in the context of IEEE 802.11 operation, a client (e.g., 110A) may operate in the standard Power Save Poll Mode (PSPM, or power-save mode, in general), as described in section 10.2.1.2 of the IEEE 802.11[TM]-2012 specification. Upon joining BSS 110, client 110A communicates to AP 110F that it (client 110A) is to operate in PSPM.

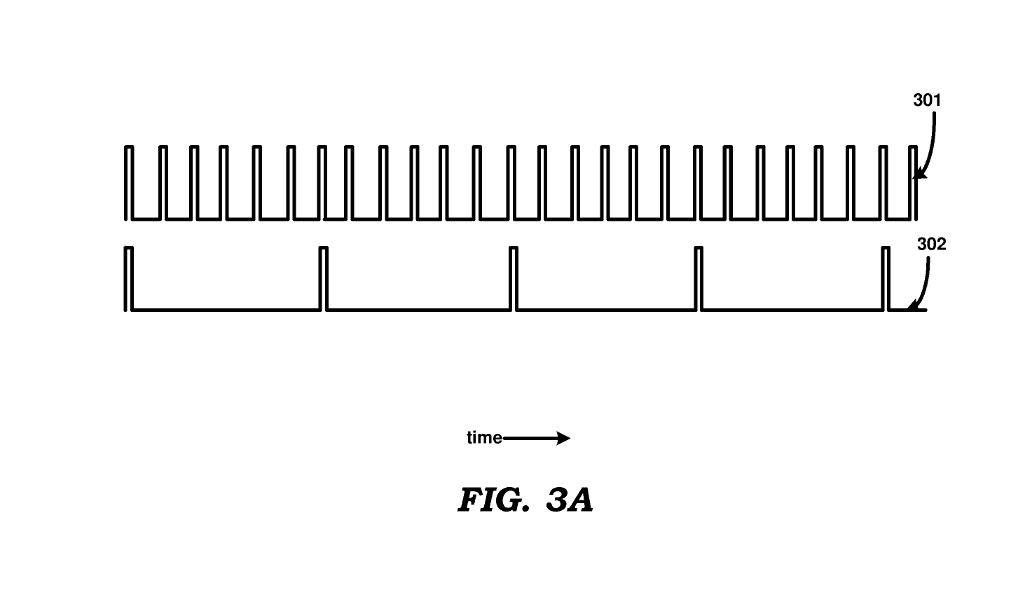

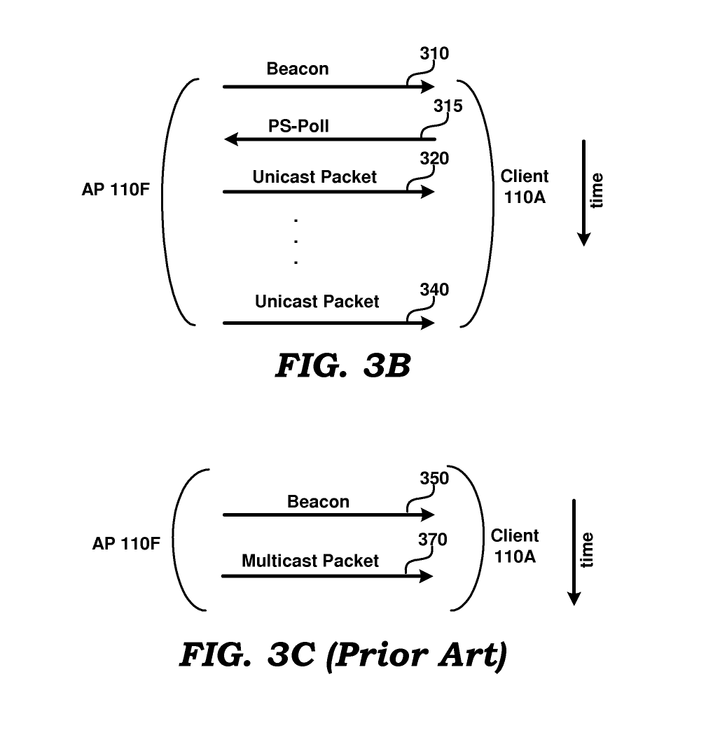

In PSPM, client 110A periodically “wakes up” (i.e., powers-ON for full functionality) from a power-OFF or reduced power state to transmit data to, or receive data from, AP 110F or the other clients of BSS 110, as illustrated in FIG. 3A. The positive pulses of waveform 301 indicate durations in which AP 110F transmits beacon frames. The positive pulses of waveform 302 indicate durations in which client 110A is awake (powered-ON) to receive transmit packets.

At least in some situations, it may be desirable to operate client 110A in sleep mode as often and as long as possible. An example is when client 110A is a temperature sensor that typically needs to update temperature measurements only once every few minutes (by comparison beacons from AP 110F are typically transmitted every 100 ms (milliseconds)). In FIG. 3A, client 110A is shown as waking up only once every six beacons of AP 110F. To support PSPM in clients, AP 110F may internally buffer any data destined for the corresponding clients.

The sequence of operations that occur in transmission of unicast data according to IEEE 802.11 from AP 110F to client 110A is illustrated in FIG. 3B. Briefly, AP 110F transmits beacon 310, with the contents of beacon 310 indicating that unicast data is available. A TIM (traffic indication message) field periodically inserted in beacon frames with a corresponding frequency (in terms of how often in beacon frames) according to IEEE 802.11 provides indication of availability of buffered unicast data for a corresponding client. Once client 110E receives a beacon with a TIM and observes that AP 110F has buffered unicast data for it (client 110A), client 110A is required to transmit a Power Save Poll (PS-Poll) frame 315. Only on receipt of frame 315 is AP 110F allowed to transmit the buffered data as unicast packet (320) to client 110A. If more data is present (as indicated by a “more data” field in frame 320), client 110A sends another PS-poll frame (not shown) and receives another unicast data packet. The sequence of messages continues till all buffered data (320-340) are received in client 110A.

It is noted that at the time of association with AP 110F, client 110A may indicate to AP 110F a sleep interval (e.g., the time duration equal to six beacons in FIG. 3A) for which client 110A would be in a sleep mode. AP 110F accordingly buffers unicast data for client 110F to ensure that data destined for client 110A is not lost/dropped.

FIG. 3C illustrates the sequence of operations that occur in transmission of multicast data according to IEEE from AP 110F to client 110A. AP 110F transmits beacon 350, with the DTIM (delivery traffic indication message) in beacon 350 indicating that multicast data is currently buffered in AP 110F and awaiting transmission to the corresponding clients (110A-110E). As shown in FIG. 3C, AP 110F is not required to wait for an availability indication (similar to the PS poll message 315), and transmits the multicast packets 370 subsequently. Thus, it is possible that client 110A (being in sleep mode) may not receive the multicast packet 370.

### 5. Solution for an Example Problem

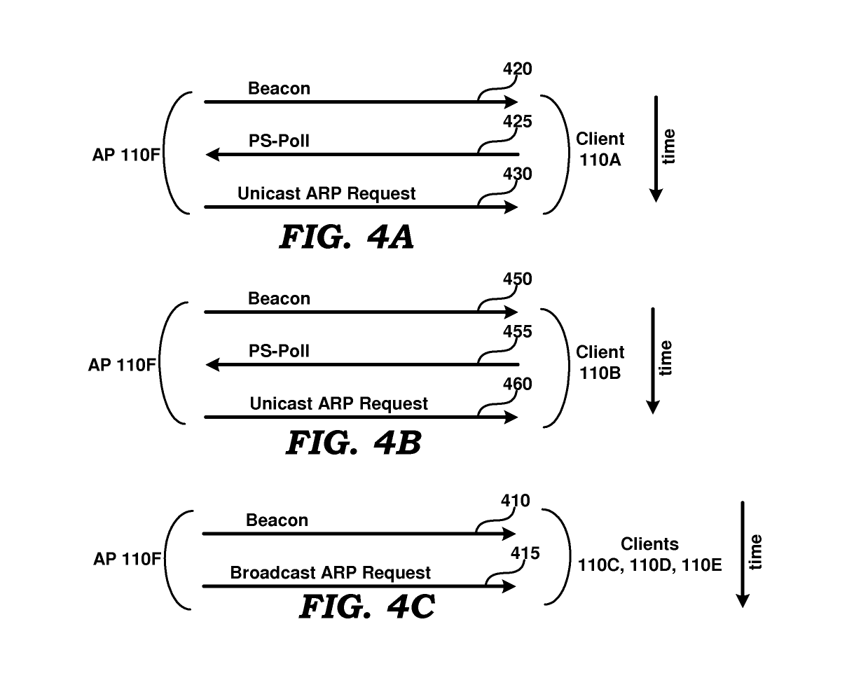

FIGS. 4A, 4B and 4C illustrate the manner in which AP 110F handles transmission of multicast packets to clients 110A-110F, in an embodiment of the present invention. It is assumed in the example of FIGS. 4A, 4B and 4C, that clients 110A and 110B are required to be treated as belonging to a special class, being clients that may need to be operated with long sleep durations. AP 110F is assumed to contain buffered data that is to be transmitted to clients 110A-110E as a multicast packet.

AP 110F is made aware, for example based on interactions with client 110A and client 110B (as noted in sections below), that clients 110A and 110B are to be treated as belonging to a special class with respect to transmission of multicast data. For example, client 110A informs, during association with AP 110F, such a requirement. Client 110A may indicate to AP 110F a requirement to be treated as belonging to the special class in vendor specific information elements (IE) of a probe request message. AP 110F may indicate support for such sleepy devices (for transmitting broadcast/multicast packets as unicast packets) as part of vendor-specific IE (information elements) of a probe response message. Alternatively, AP 110F may broadcast beacons indicating support for clients of the special class, and client 110A may thereafter request AP 110F for such support.

While the determination of whether a client is to be treated as belonging to a special class is noted above as being made based on whether or not the client is to operate as a sleepy device, the determination may be made on other considerations as well.

For illustration, it is now assumed that an ARP (Address Resolution Protocol) request is received by AP 110F, for forwarding to each of the clients in BSS 110. For example, if a device in a same IP (Internet Protocol) subnet as clients 110A-110E needs to send data to one (say client 110A) of clients 110A-110B, but does not have the MAC address of client 110A (i.e., does not have a corresponding ARP entry), the device may send an ARP request to AP 110F for eventual delivery to clients 110A-110E.

Given that there are two devices 110A/110B, which have previously registered with the special status, AP 110F forms a unicast packet containing the ARP request. As shown in FIG. 4A, AP 110F indicates to client 110A in beacon 420 that unicast data (the ARP request here) is available for delivery. Client 110A sends a PS-Poll message (425) in response, indicating its availability for receiving the unicast data. In response AP 110F transmits the ARP request as a unicast packet (430) to client 110A. Depending on its MAC address, client 110A may respond accordingly to unicast packet 430.

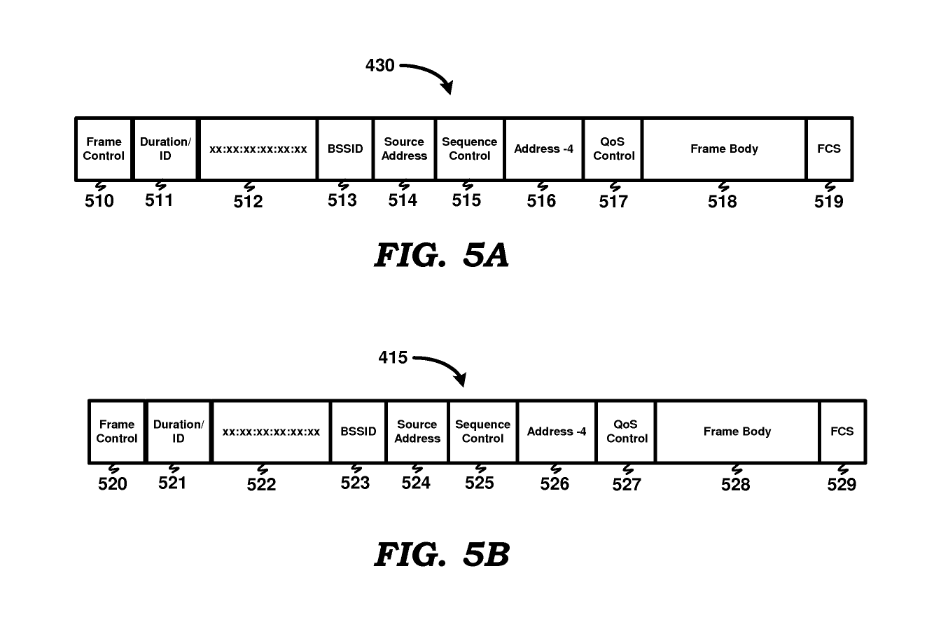

Similarly, as shown in FIG. 4B, AP 110F indicates to client 110B in beacon 450 that unicast data (the ARP request here) is available for delivery. Client 110B sends a PS-Poll message (455) in response, indicating its availability for receiving the unicast data. In response AP 110F transmits the ARP request as a unicast packet (460) to client 110B. Depending on its MAC address, client 110B may respond accordingly to unicast packet 460. The fields of unicast packet 460 would be similar to that illustrated in FIG. 5A, except that the MAC address field would now contain the MAC address of wireless client 110B.

With reference to FIGS. 4A and 4B, it is noted that AP 110F may be designed to support longer buffering capacity for unicast packets destined for client 110A and client 110B than for the other clients of BSS 110. Thus, the corresponding PS-poll frames (425 and 455) may be transmitted by clients 110A and 110B respectively only after the expiry of the immediately previous sleep interval, which can now be long and limited only by the buffering capacity in AP 110F.

FIG. 5A shows the various fields of a unicast packet (e.g., 430) as may be transmitted by AP 110F. Fields 510, 511, 512, 513, 514, 515, 516 and 517 together form the MAC header. Destination MAC address field 512 contains the MAC address xx:xx:xx:xx:xx:xx (x being one of values 0 through F) of client 110A. Frame body 518 contains the payload specifying the ARP request. Frame control 510 specifies control information used for defining the type of 802.11 MAC frame. Duration/ID 511 specifies the remaining duration needed to receive the next frame transmission. BSSID 513 is a unique identifier of BSS 110. Source address 514 specifies the MAC address of the MAC address of the device that generated the ARP request. Sequence control 515 indicates the sequence number of each frame, as well as the number of each frame sent of a fragmented frame. Address-4 516 is a ‘don't care’ or not applicable. QoS Control 517 identifies the quality-of-service (QoS) parameters of the data frame (packet 430). FCS 519 represents a cyclic redundancy check (CRC) value over all the fields of the MAC header and the frame body.

Since clients 110C, 110D and 110E do not belong to the special class, AP 110F transmits the ARP request as ‘regular’ multicast packet, as illustrated in FIG. 4C. AP 110F transmits beacon 410 indicating the presence of buffered multicast packets, and subsequently transmits the packet (415). The corresponding one of clients 110C-110E may thereafter respond to packet 415.

FIG. 5B shows the various fields of multicast packet 415. Fields 520, 521, 522, 523, 524, 525, 526 and 527 together form the MAC header. Fields 520, 521, 522, 523, 524, 525, 526, 527, 528 and 529 have the same meanings respectively as fields 510, 511, 512, 513, 514, 515, 516, 517, 518 and 519 of FIG. 5A. Destination MAC address field 522 contains either a multicast address (01:00:5 E:xx:xx:xx) or a broadcast address (FF:FF:FF:FF:FF:FF) depending on whether packet 415 is a multicast or broadcast packet. When packet 415 is a multicast packet, the specific group of clients 110C-110E that is to be the recipient of packet 415 is specified by the specific value of xx-xx-xx. As noted above, in case of ARP packets, a LAN broadcast is used.

Another benefit of the approach of the flowchart of FIG. 2 is that group key updates to special class clients 110A and 110B may no longer be required. According to the IEEE 802.11 standard, group keys are used for encrypting and decrypting multicast data. Group keys are described in further detail in section 8.5 of IEEE[TM] 802.11-2007 specification. In a given interval, each of clients 110A-110E is provided by AP 110F a (same) group key to decrypt/encrypt multicast data. The group key is sent as a unicast packet to each of clients 110A-110E. For enhanced security, AP 110F may change the group key repeatedly (e.g., at regular intervals). Once the group key is changed, AP 110F needs to communicate the new group key to all clients 110A-110F prior to transmitting the next multicast data packet.

Typically, the duration of buffering (within AP 110F) of a new group key is short to ensure greater (or faster enforcement of) security in the WLAN. Thus, for example, it may not be a practical solution to have AP 110F buffer the new group key, as well as to delay transmission of the next multicast packet, for too long a duration. Further, non-acknowledgement of a group key update may potentially result in client 110A being dissociated from the WLAN. With the technique of FIG. 2, however, there is no longer a requirement for client 110A to receive any group key updates, since all multicast packets are delivered as corresponding unicast packets to client 110A (at least assuming that a shared special status list is used for all multicast/broadcast addresses).

AP 110F can be implemented in various embodiments as a desired combination of one or more of hardware, executable modules, and firmware. The description is continued with respect to an example embodiment in which various features are operative when corresponding instructions are executed by a processor.

### 6. Access Point

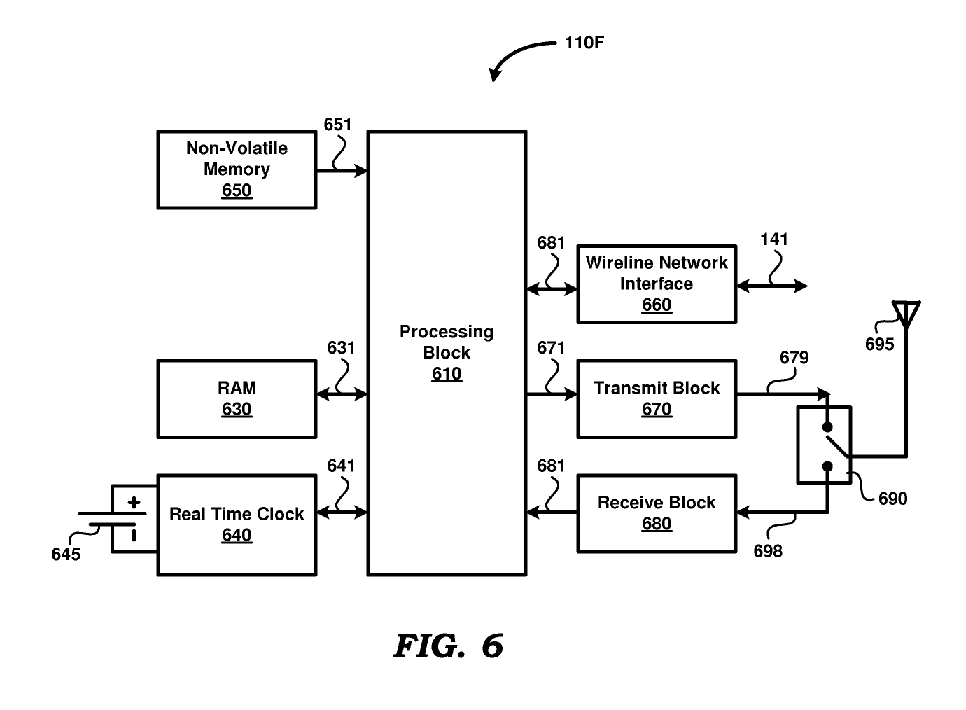

FIG. 6 is a block diagram of the internal details of a wireless station (either AP 110F or any of clients 110A-110E) in an embodiment. The description below refers to the wireless station of FIG. 6 as being AP 110F, although the station can represent any of clients 110A-110E as well (with suitable modifications). AP 110F is shown containing processing block 610, flash memory 620, random access memory (RAM) 630, real-time clock (RTC) 640, battery 645, non-volatile memory 650, wireline network interface 660, transmit block 670, receive block 680, switch 690 and antenna 695. The whole of AP 110F may be implemented as a system-on-chip (SoC), except for battery 645. Alternatively, the blocks of FIG. 6 may be implemented on separate integrated circuits (IC).

Again, the components/blocks of FIG. 6 are shown merely by way of illustration. However, AP 110F may contain more or fewer components/blocks. Further, although not shown in FIG. 6, all blocks of AP 110F may be connected automatically to an auxiliary power source (such as battery 645) in the event of failure of main power source (not shown).

Wireline network interface provides AP 110F connection to wired backbone 140 via path 141 (FIG. 1), and may be implemented according to one of several well-known wireline network technologies.

Antenna 695 operates to receive from and transmit to a wireless medium, corresponding wireless signals (e.g., according to IEEE 802.11) containing data. Switch 690 may be controlled by processing block 610 (connection not shown) to connect antenna 695 either to receive block 680 via path 698, or to transmit block 670 via path 679, depending on whether AP 110F is to receive or transmit.

Transmit block 670 receives data to be transmitted on path 671 from processing block 610, generates a modulated radio frequency (RF) signal according to IEEE 802.11 standards, and transmits the RF signal via switch 690 and antenna 695. Receive block 680 receives an RF signal bearing data via switch 690 and antenna 695, demodulates the RF signal, and provides the extracted data to processing block 610 on path 681.

RTC 640 operates as a clock, and provides the ‘current’ time to processing block 610 on path 641. RTC 640 may be backed-up by battery 645 (in addition to the normal source of power, not shown in the Figure). RTC 640 may also contain memory to store critical information received from processing block 610. Although not shown as such in FIG. 6, battery 645 may also be used as back-up power to one or more of the other components/blocks of AP 110F.

Non-volatile memory 650 is a non-transitory machine readable medium, and stores instructions, which when executed by processing block 610, causes AP 110F to provide several desired features according to the present invention. RAM 630 and non-volatile memory 650 (which may be implemented in the form of read-only memory/ROM/Flash/EEPROM, etc.) constitute computer program products or machine (or computer) readable medium, which are means for providing instructions to processing block 610. Thus, such medium can be in the form of removable (floppy, CDs, tape, etc.) or non-removable (hard drive, etc.) medium.

Processing block 610 (or processor in general) may contain multiple processing units internally, with each processing unit potentially being designed for a specific task. Alternatively, processing block 610 may contain only a single general-purpose processing unit. Processing block 610 may retrieve the instructions (via corresponding paths 651 and 631), and execute the instructions to provide several features of the present invention described above.

In particular, processing block 610 may interface with the clients to determine the members of special status. A separate list may be maintained for each broadcast/multicast address since only some of the clients may be members of some of the multicast groups. Accordingly, each client may be required to indicate the specific multicast addresses for which the client is to be treated with special status. A client of special status for any multicast address is treated as similar status for broadcast address. The lists thus formed, may be stored in RAM 620. Alternatively, only a single list for all the multicast addresses together, may be maintained. Processing block 610, when processing data specified for transmission/forwarding as multicast packets, examines the corresponding list in RAM 620, in determining the specific clients to which the data to be forwarded in the form of unicast packets as in step 260.

### 7. Conclusion

References throughout this specification to “one embodiment”, “an embodiment”, or similar language means that a particular feature, structure, or characteristic described in connection with the embodiment is included in at least one embodiment of the present invention. Thus, appearances of the phrases “in one embodiment”, “in an embodiment” and similar language throughout this specification may, but do not necessarily, all refer to the same embodiment.

While various embodiments of the present invention have been described above, it should be understood that they have been presented by way of example only, and not limitation. Thus, the breadth and scope of the present invention should not be limited by any of the above-described embodiments, but should be defined only in accordance with the following claims and their equivalents.

What is claimed is:

1. A method of reliably delivering data in a wireless local area network (WLAN), said WLAN comprising an access point (AP) and a plurality of wireless clients, said method being implemented in said AP, said method comprising:
maintaining data indicating a list of wireless clients in said plurality of wireless clients that belong to a special class;
receiving data, which is to be transmitted on said WLAN in the form of a multicast packet;
examining said list to determine whether any wireless client is present in said special class; and
if said examining determines that no wireless client is present in said special class, then transmitting said data as said multicast packet on said WLAN,
but if said examining determines that wireless clients are present in said special class, then transmitting said data in the form of unicast packets on said WLAN to each wireless client of said special class in addition to transmitting said data as said multicast packet on said WLAN.

2. The method of claim 1, wherein membership to said special class is based on a requirement of a duration of a power-down interval of a wireless client operating in Power-Save Poll mode (PSPM),
wherein a first client having a longer duration for said power-down interval is included in said list and a second client having a shorter duration for said power-down interval is not included in said list, wherein each of said first client and said second client is comprised in said plurality of clients.

3. The method of claim 2, wherein, prior to transmitting said data in the form of a first unicast packet, said AP transmits a first beacon frame indicating that said first unicast packet is available for delivery to a corresponding wireless client of said special class,
wherein said corresponding wireless client transmits a PS-Poll frame in response to receipt of said first beacon frame,
said AP transmitting said data in the form of said first unicast packet only upon receipt of said PS-Poll frame.

4. The method of claim 3, wherein, prior to transmitting said data as said multicast packet on said WLAN, said AP transmits a second beacon frame indicating that said multicast packet is available for delivery,
said AP thereafter transmitting said multicast packet without waiting to receive a confirmation of availability from said wireless clients to receive said multicast packet.

5. The method of claim 4, wherein said multicast packet is an address resolution protocol (ARP) request packet.

6. The method of claim 2, wherein said first client requests for membership to said special class during association with said AP.

7. The method of claim 2, wherein said first client requests for membership to said special class in a vendor-specific information element (IE) of a probe request message transmitted to said AP.

8. The method of claim 2, wherein said AP indicates support for clients of said special class in one or both of a beacon frame and a vendor-specific information element (IE) of a probe response message.

9. The method of claim 2, wherein said AP is designed to be able to buffer data destined for said first client for a longer duration than data destined for said second client.

10. The method of claim 2, wherein said AP disables group key updates for wireless clients of said special class.

11. A non-transitory machine readable medium storing one or more sequences of instructions for execution by one or more processors in an access point (AP) of a wireless local area network (WLAN), wherein said WLAN also includes a plurality of wireless clients, wherein execution of said one or more sequences of instructions by said one or more processors causes said AP to perform the actions of:
maintaining data indicating a list of wireless clients in said plurality of wireless clients that belong to a special class;
receiving data, which is to be transmitted on said WLAN in the form of a multicast packet;
examining said list to determine whether any wireless client is present in said special class; and
if said examining determines that no wireless client is present in said special class, then transmitting said data as said multicast packet on said WLAN,
but if said examining determines that wireless clients are present in said special class, then transmitting said data in the form of unicast packets on said WLAN to each wireless client of said special class in addition to transmitting said data as said multicast packet on said WLAN.

12. The non-transitory machine readable medium of claim 11, wherein membership to said special class is based on a requirement of a duration of a power-down interval of a wireless client operating in Power-Save Poll mode (PSPM),
wherein a first client having a longer duration for said power-down interval is included in said list and a second client having a shorter duration for said power-down interval is not included in said list, wherein each of said first client and said second client is comprised in said plurality of clients.

13. The non-transitory machine readable medium of claim 12, wherein, prior to transmitting said data in the form of a first unicast packet, said AP transmits a first beacon frame indicating that said first unicast packet is available for delivery to a corresponding wireless client of said special class,
wherein said corresponding wireless client transmits a PS-Poll frame in response to receipt of said first beacon frame,
said AP transmitting said data in the form of said first unicast packet only upon receipt of said PS-Poll frame.

14. The non-transitory machine readable medium of claim 13, wherein, prior to transmitting said data as said multicast packet on said WLAN, said AP transmits a second beacon frame indicating that said multicast packet is available for delivery,
said AP thereafter transmitting said multicast packet without waiting to receive a confirmation of availability from said wireless clients to receive said multicast packet.

15. The non-transitory machine readable medium of claim 14, wherein said multicast packet is an address resolution protocol (ARP) request packet.

16. An Access Point (AP) of a wireless local area network (WLAN), wherein said WLAN also includes a plurality of wireless clients, said AP comprising:
a memory to store instructions;
a processor to retrieve instructions from said memory and to execute said instructions, wherein execution of said retrieved instructions causes said AP to perform the actions of:
maintaining data indicating a list of wireless clients in said plurality of wireless clients that belong to a special class;
receiving data, which is to be transmitted on said WLAN in the form of a multicast packet;
examining said list to determine whether any wireless client is present in said special class; and
if said examining determines that no wireless client is present in said special class, then transmitting said data as said multicast packet on said WLAN,
but if said examining determines that wireless clients are present in said special class, then transmitting said data in the form of unicast packets on said WLAN to each wireless client of said special class in addition to transmitting said data as said multicast packet on said WLAN.

17. The AP of claim 16, wherein membership to said special class is based on a requirement of a duration of a power-down interval of a wireless client operating in Power-Save Poll mode (PSPM),
wherein a first client having a longer duration for said power-down interval is included in said list and a second client having a shorter duration for said power-down interval is not included in said list, wherein each of said first client and said second client is comprised in said plurality of clients.

18. The AP of claim 17, wherein, prior to transmitting said data in the form of a first unicast packet, said AP transmits a first beacon frame indicating that said first unicast packet is available for delivery to a corresponding wireless client of said special class,
wherein said corresponding wireless client transmits a PS-Poll frame in response to receipt of said first beacon frame,
said AP transmitting said data in the form of said first unicast packet only upon receipt of said PS-Poll frame.

19. The AP of claim 18, wherein, prior to transmitting said data as said multicast packet on said WLAN, said AP transmits a second beacon frame indicating that said multicast packet is available for delivery,
said AP thereafter transmitting said multicast packet without waiting to receive a confirmation of availability from said wireless clients to receive said multicast packet.

20. The AP of claim 16, wherein said multicast packet is an address resolution protocol (ARP) request packet.
